(19) United States
(12) Patent Application Publication
(10) Pub. No.: US 2010/0005305 A1
(43) Pub. Date: Jan. 7, 2010

(54) APPARATUSES, AND METHODS FOR INSERTING USER DATA INTO DIGITAL MULTIMEDIA SIGNALS

(76) Inventor: Amitabh Dixit, Farmers Branch, TX (US)

Correspondence Address: AMITABH DIXIT, 1300 LAKERIDGE LN., IRVING, TX, 75063, US

(21) Appl. No.: 12/166,165

(22) Filed: Jul. 1, 2008

(51) Int. Cl. H04L 9/06

(52) U.S. Cl. 713/176

(57) ABSTRACT

Apparatuses, and methods for inserting user data into digital multimedia signals are provided in which user data is inserted into the digital multimedia signals in a substantially imperceptible fashion. In one embodiment of the invention, digital watermarking techniques are used to embed user data into the digital multimedia signal, such that user data is later helpful in indexing the digital multimedia signal. User data can be in any generic form such as text, audio or video signals. In another embodiment of the invention, user data is superimposed on the digital multimedia signal at a location which contains the least amount of information. In yet another embodiment of the invention, user data is inserted at a location chosen by the user. The color in which user data is superimposed can also be chosen by the user by using either a color palette or by pointing to an area in the digital image or video.

### FIELD OF THE INVENTION

Embodiments of the present invention relate generally to technology associated with embedding user specified data into a host signal and more particularly, relate to methods and apparatuses for embedding a variety of data substantially imperceptibly into digital multimedia signals, such that this data is useful in indexing the digital multimedia signals.

### BACKGROUND OF THE INVENTION

Multimedia content, such as images and videos, are predominantly captured in digital format rather than in analog format. Even if the content is captured in analog format, more often than not, the content is converted into digital format for editing and storage. There are various reasons for this shift, not the least among which are the ease and economy with which digital content can be captured, edited and viewed. One of the most prominent manifestations of this shift from analog domain to the digital domain is in the area of still imaging and video capturing devices. Where analog cameras which capture images on a photographic film were predominant just a few years ago, in recent years, digital imaging devices in the form of digital cameras, digital video recorders and cellular phones equipped with image and video capturing capabilities, have by far surpassed their analog counterparts in popularity and in sales.

A convenience that results from capturing or converting multimedia content into digital format is the ease of adding chronological information to the digital multimedia content, which can be later used to index and categorize this content. Consider the example of still imaging. It is not uncommon for people to take pictures and after viewing them a few times soon after capturing, to store them away for several months or even years before they view the pictures again. When the images are viewed again, a significant time after the image capture, it is likely that people will forget the precise date, time or circumstances associated with image capture. In such a situation, if user data, such as chronological data, associated with an image is available, it can be very useful in indexing and categorizing the images.

With images captured on a photographic film, printing of pictures on paper is necessary to view them. Hence, the only practical option available to the owner of the images for indexing the images is to create and maintain bulky photo albums and write notes on the back-side of the pictures themselves or in the space adjacent to the pictures in the photo album.

However, with most of the imaging today being performed digitally, it is not necessary to print pictures on paper to be able to view them. In fact, most people nowadays store majority of their images only on digital memory, such as computer hard disks, and do not print them on paper. In such a situation, indexing of images becomes a problem. Is it to be noted that in this disclosure, computers are defined to include desktop computers, laptop computers, personal digital assistants, phones, camera phones, digital cameras and all other electronic portable or non-portable devices, which contain a processor and have the ability to process signals.

Modem day digital cameras (digital cameras are defined to include any digital imaging device including camera phones) at times provide a solution to this problem, which though inadequate, still serves a limited purpose. Most present day digital cameras are capable of superimposing a predetermined data type such as time and date on a captured image to remind the user of the time and/or day when the image was captured. FIGS. 1 and 2 demonstrate this technique. FIG. 1 illustrates an exemplary user image and FIG. 2 illustrates the same image with date stamp superimposed on it. This superimposition of date stamp is useful in indexing digital pictures, since indexing digital pictures otherwise (either by storing them in specific directories on a computer or by giving them descriptive names or code-names) is a tedious bookkeeping task which is either avoided by most people or is not carried out meticulously enough to be of much use in future. However, this technique of superimposing predetermined data has some glaring drawbacks: Firstly, most digital cameras allow the user to insert only few pre-determined data types which are very limited in scope; mainly date and time stamp. If the user wishes to add additional notes to the image, he/she is unable to do so. Say, the user wishes to add the following note to an image: “Tommy's first steps at 11:45 am on Dec. 1, 2007” or “Dinner at Ristorante Italiano on the first night of our honeymoon vacation in Hawaii”, the user is unable to do so since current digital imaging devices are unable to provide this service. Furthermore, even if this whole text is superimposed on the image like what is done in current digital imaging devices with the date or time stamp, it will significantly degrade the quality of the image and hence will be unacceptable. Consider another example: In the event that a person is visiting a museum, it is very desirable for the person to take a picture and be able to associate user data with the image to later remind him/her of the identity of the artifact in the image. An example of such user data is: “Standing figure of the Buddha Sakyamuni Eastern India, probably Bihar, Late 6th—early 7th century, Copper alloy. Height 35.5 cm (14 inches), Victoria and Albert Museum, London”. Currently, the only way to achieve this is to take tedious handwritten notes or use a separate electronic voice recorder. Apart from the inconvenience to the user, another major drawback is that there is no direct association between the captured image and the user data and there is a possibility of user data being mismatched with another image later on. These are but few of the numerous situations where current techniques for adding user data fall short of adequate.

Secondly, addition of user specified data is strictly restricted to a predetermined location, regardless of the information content at that location. Hence, if this superimposed data obstructs some critical area of the image and if the image can not be recaptured (for example, if it was taken during a vacation in an exotic location which the person is unlikely to revisit or during a special event/celebration such as a child taking his/her first step or a birthday), it can cause considerable anguish to the user. Since it is impossible to determine in advance which minuscule area of the image will contain the most valuable information, it is highly likely that at least few images will be spoiled by this superimposition of data. Needless to say, most images marking a special moment can not be recaptured and every attempt must be made to obstruct as little of the image area as possible.

Thirdly, superimposing user data on the image reduces the aesthetic quality of the image even if the superimposed text does not hide a critical or information rich area of the image (compare FIG. 1 to FIG. 2). Fourthly, the prior art techniques allow the user to only add data in form of text and are unable to add audio or video notes to the image. Finally, since the user does not have a choice of color of the superimposed text, the superimposed data generally is an eye sore. This problem is more serious when it is desired to print the digital picture or to frame it.

Given the above described limitations and problems, it may be advantageous to provide an improved method and apparatus for embedding and extracting user data in and out of digital multimedia signals.

The invention described herein overcomes the above described and many more drawbacks and presents an elegant solution to the problem of adding user data of varied type to digital multimedia content without degrading the aesthetic quality of the content. In one aspect of the invention, this problem is solved with the aid of digital watermarking techniques. Digital watermarking is the process of inserting one or more sequence of bits, called digital watermark, into a digital signal referred to as the host signal. The watermarks may be used to carry any type of information which has been converted to binary form. Examples include text, audio and video. As an example, U.S. Pat. No. 6,643,386 discloses a method and apparatus for adding watermarks to images and/or video data streams. Numerous techniques exist for digital watermarking, examples of which range from computationally simpler techniques which replace a bit or few bits at a predetermined location (ex.: the least significant bit or few least significant bits) in the binary representation of selected pixel values, to more sophisticated transform domain watermarking techniques such as a wavelet domain watermarking technique disclosed in U.S. Pat. No. 6,385,329.

A digital watermark may be perceptible or imperceptible. Introduction of an imperceptible watermark alters a digital signal in such a way that the alterations to the original signal are either completely imperceptible or at the very least, imperceptible to casual inspection. One technique of introducing an imperceptible or invisible watermark in a digital image is by replacing the least significant bit of each pixel value by one of the watermark bits. This modification of the least significant bit is generally imperceptible since changing the least significant bit out of a group of twenty four bits (assuming a color image, where color of each point in the image is determined jointly by the eight bit value assigned to each of the red, green and blue pixels) used to represent a point in a color image does not visibly alter the image in a vast majority of cases. In the embodiments of this invention, we will mostly deal with imperceptible watermarks.

Imperceptible watermarking techniques have been heavily used in the art to achieve various goals, most notable among which are image authentication and integrity. To facilitate image authentication, an imperceptible watermark in embedded in the image. The watermark typically includes information about the ownership of the image, its identity, such as a unique code number, or some kind of copyright notice. Later, to determine whether the image is authentic or not, the watermark is extracted from the image. If the extracted watermark is the same as the original watermark which was inserted into the image, the image is deemed authentic, otherwise not. Also, the extracted watermark can be used to determine whether the image has been altered based upon the assumption that an alteration to the image will also alter the watermark. United States patent application “US 20070110275” discloses techniques for using embedded watermarks to track document history, determine document version information, and enhance overall security.

Imperceptible watermarking has also been used for the purpose of steganography or hiding information in plain sight. In steganography applications, a secret message is imperceptibly inserted into a host image and is later extracted by the intended user. Most steganographic techniques are based upon the assumption that no one but the sender and the intended recipient are aware of the existence of the invisible message in the host image.

United States patent application “US 20050169499” describes a method for introducing digital watermark into a digital image at the time of capture of the digital image whereby location information is embedded therein using steganography techniques. This location information can be used to visually or graphically identifying locations on a map which can be displayed via a computer display. The method includes receiving data representing a first image, and analyzing the data to obtain information steganographically encoded therein. The information includes or links to first location information associated with the first image. The method further includes providing a map including an area associated with the first location information. This technique too suffers from the numerous disadvantages of the techniques listed earlier, one among which is that only a certain data type can be introduced into the host multimedia signal and user does not have the flexibility to introduce various data types (text, audio, video).

### BRIEF SUMMARY OF THE INVENTION

A method and apparatus are therefore provided that allow for insertion of user data into a digital multimedia signal in a least perceptible way such that the aesthetic quality of the multimedia signal is least affected. The insertion may include embedding user data in the form of a digital watermark into the host digital multimedia signal or superimposing user data onto the host multimedia signal in a least obstructive fashion.

In one exemplary embodiment, a method for introducing user data into a digital multimedia signal is provided such that the digital multimedia signal is perceptually substantially unchanged (change is not detectable via casual inspection) and wherein user data comprises information helpful in indexing the digital multimedia signal. Embedding of user data may be done substantially concurrently with the capture of the digital multimedia signal, or it may be done at another time when the circumstances relating to the image capture are still fresh in the user's memory. The method may include receiving user data as a text, audio, or video input directly from the user or by reading a digital file in which a user might have stored this information a priori. User information may relate to the date, time or events associated with the capture of the multimedia content. The method may further include user data in the form of images, audio recordings, and video recordings. The method may include embedding user data using a digital watermarking technique for imperceptibly embedding watermarks. Any of the numerous digital watermarking techniques can be used to embed user data as an imperceptible digital watermark. Furthermore, the method may include extracting the digital watermark and outputting the embedded user data to a user. The output to the user could be in form of a text, audio or video display.

In another exemplary embodiment of the invention, a method is provided which allows superimposing user data into a digital multimedia signal at a location in the multimedia object which substantially has low spatial frequency; wherein user data comprises information helpful in indexing the digital multimedia signal. The method may further include superimposing user data into a digital multimedia signal at a location selectable by user. The method may further include superimposition of user data in a color selectable by the user. The method may further include superimposition in a color which is substantially similar to the color of the background at the location of the superimposition.

In another exemplary embodiment, a computer program product for inserting user data into a host multimedia signal is provided. The computer program product may include first, second, and third executable portions stored on a computer-readable medium. The first executable portion may receive user data from the user or a stored digital file and may receive the host multimedia signal. The second executable portion may embed the user data into the host multimedia signal. And the third executable portion may extract user data from the multimedia signal. For example, the second executable portion of the computer program product may use a digital watermarking technique to embed user data into the host multimedia signal or it may superimpose user data into a location which may least degrade the aesthetic quality of the image.

In another exemplary embodiment of the invention, an apparatus is provided. The apparatus may include a receiver for receiving a digital multimedia signal, a receiver for receiving user data, and a processor for embedding user data into a digital multimedia signal such that the digital multimedia signal is perceptually substantially unchanged. The apparatus may further include a digital imaging apparatus for capturing digital multimedia signals. The apparatus may further include a screen for displaying digital multimedia objects. The apparatus may further include an input device capable of accepting inputs from the user.

In another exemplary embodiment of the invention, an apparatus is provided. The apparatus may include a receiver for receiving a digital multimedia signal, a receiver for receiving user data, and a processor for superimposing user data into a digital multimedia signal at a location in the multimedia object which has substantially low frequency content.

In another exemplary embodiment of the invention, an apparatus is provided. The apparatus may include a receiver for receiving a digital multimedia signal, a receiver for receiving user data, and a processor for superimposing user data into a digital multimedia signal at a location selectable by the user. The apparatus may include a selector for selecting the color in which the user data is superimposed on the digital multimedia object such that the color can be chosen by pointing to a spatial location in the digital multimedia object.

In another exemplary embodiment of the invention, an apparatus is provided. The apparatus may include a receiver for receiving a digital multimedia signal in which user data has been embedded in a substantially imperceptible fashion, a processor for extracting user data from the digital multimedia object, and an output device for outputting the user data.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a host image without any user data embedded or superimposed on it;

FIG. 2 illustrates the result of prior art technique of superimposition of a date stamp on the host image of FIG. 1;

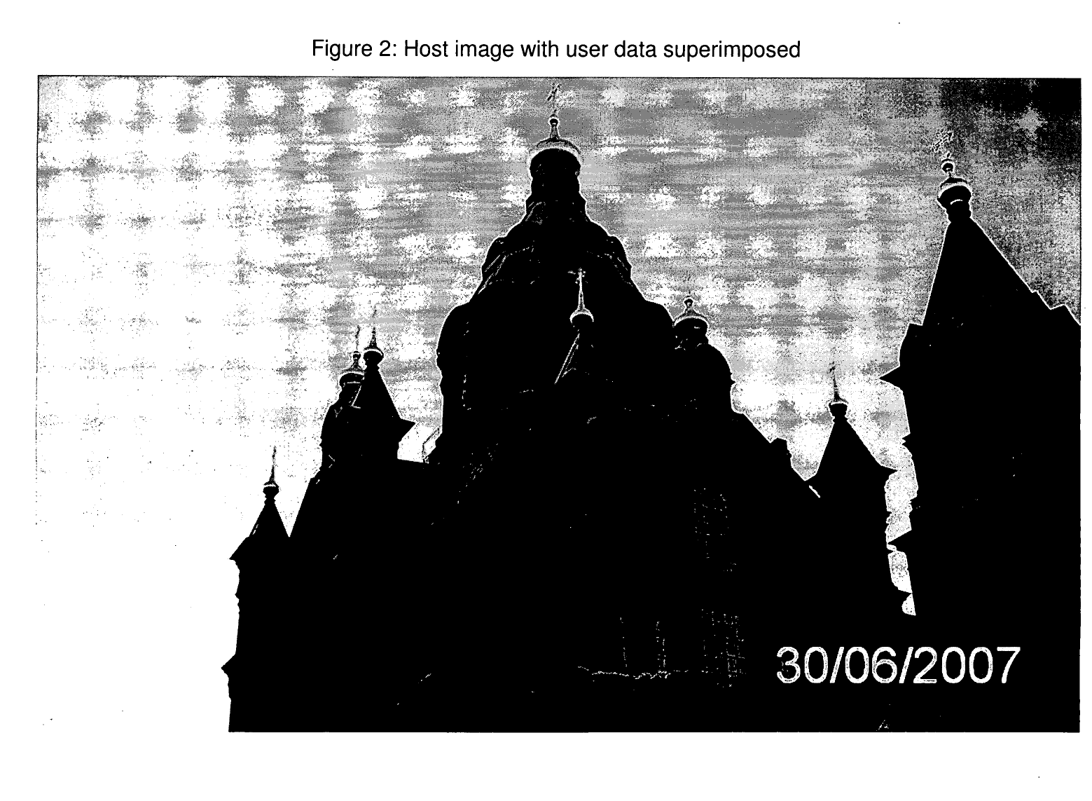

FIG. 3 illustrates a process of embedding and extracting user data into a digital multimedia signal according to an embodiment of the present invention;

FIG. 4 illustrates a method according to yet another embodiment of the invention;

FIG. 5 illustrates the host image of FIG. 1 with ten seconds of user speech data embedded into it according to an embodiment of the invention; and

FIG. 6 illustrates yet another embodiment of the invention.

### DETAILED DESCRIPTION OF THE INVENTION

Embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

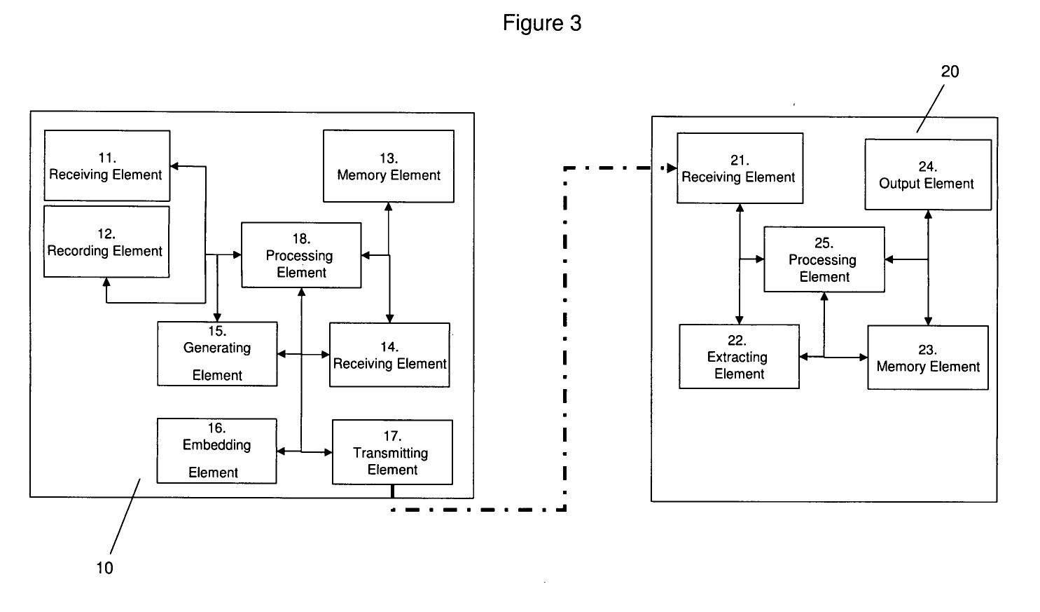

Embodiments of the present invention relate to embedding imperceptible user data into an information signal such as a multimedia signal. As shown in FIG. 3, the process of embedding user data in a multimedia signal and later extracting it to index the multimedia signal may involve two primary devices. The first device 10 is for creating or receiving an original multimedia signal and creating or receiving user data and embedding or inserting user data into the original multimedia signal. The second device 20 is for receiving a multimedia signal with embedded user data and extracting user data embedded within the received multimedia signal useful in indexing the multimedia signal. Although described as a first device 10 and second device 20, one in the art would appreciate that the first and second device are not necessary two independent devices but may be one device or one system that includes the components and functions of both the first and second devices described herein.

The first device creates or receives the digital multimedia signal. The digital multimedia signal may be in the form of a digital file or signal and may represent images (photographs, graphics, drawings) or video content. The first device may be a computer or communication device configured to receive digital data. For example, the first device may be a digital camera, digital video recorder, desktop computer, a laptop computer, a server, a mobile telephone, a portable digital assistant, or other type of portable or stationary digital imaging device or computer or communication device and include all necessary software, controllers, memory devices, connections, antennas, modems, disk drives, and other accessories to operate such devices. The manner in which the first device receives the digital data may vary. For example, the first device may receive the digital multimedia signal through a network, such as the Internet or an intranet, as an electronic mail, or in accordance with other downloading formats or processes. The first device may be capable of creating a digital multimedia signal instead of or in addition to receiving the digital multimedia signal. For example, the first device may include a recording element such as a digital camera, video recorder, or scanner for creating the digital multimedia signal and the necessary software and accessories to operate such elements.

The first device is also configured to insert or embed user data into the digital multimedia signal. As such, the first device includes all the necessary hardware and software, including programs, computer readable memory devices, and controllers for processing and embedding user data into the digital multimedia signal. The first device may be configured to generate user data for insertion and/or receive user data from an outside source for insertion. User data may be in the form of text, audio or video signal. The user data may be predetermined (such as date and/or time related to an event associated with the multimedia signal). This data may be then inserted an as imperceptible digital watermark into the host multimedia signal. An imperceptible digital watermark is a sequence of bits that may represent information useful in indexing the digital multimedia signal. The insertion strategy, i.e. the placement of the watermark throughout the digital multimedia signal, may vary including inserting the watermark in either a spatial domain or in a transform domain, such as discrete cosine transform coefficients or wavelet coefficients. In general, the insertion strategy is to embed the user data such that the user data is “hidden”, i.e. it has little or no perceptible impact on the digital multimedia signal. For example, in a digital multimedia signal that represents an image, user data may be embedded as a watermark through the least significant bit or bits of a number of pixels of the image such that the watermark has little or no perceptible impact on the quality of the image. By hiding user data as a watermark, aesthetic quality of the multimedia signal is preserved.

According to the illustrated embodiment of FIG. 3, the first device 10 includes a receiving element 11, such as an antenna, a receiver or other input device, for receiving digital multimedia signals, a recording element 12 for creating digital multimedia signals, a memory element 13 for storing digital multimedia signals (both prior to and after insertion of user data) and user data, a receiving element 14, such as an antenna, a receiver or other input device, for receiving user data, a generating element 15 for generating user data, an embedding element 16 for inserting user data into digital multimedia signals, a transmitting element 17, such as an antenna, a transmitter or other output device, for transmitting the digital multimedia signals with embedded user data, and a processing element 18 configured to regulate or control the functions of the other elements. The processing element may be comprised of a processor or other computing device and may serve not only to regulate or control the functions of the other elements, but may, in fact, serve as one or more of the other elements, such as the recording element, the generating element and/or the embedding element.

According to the illustrated embodiment of FIG. 3, the first device 10 either creates a digital multimedia signal via the recording element 12 or receives it via the receiving element 11. Also, the device 10 either generates the user data signal via element 15 or receives it via the receiving element 14. The digital multimedia signal, for example, could be a digital image captured by a digital camera and the user data, for example, can be an audio signal recorded by the user soon after or prior to the capture of a digital image. The user may include not only the date and time of the image capture but also the other detailed miscellaneous notes such as “Standing figure of the Buddha Sakyamuni Eastern India, probably Bihar, Late 6th—early 7th century, Copper alloy. Height 35.5 cm (14 inches), Victoria and Albert Museum, London”. The user data can be embedded into the multimedia signal using one of various known watermarking techniques as an imperceptible watermark, without affecting the aesthetic quality of the image.

As used herein, a “host signal” is the digital multimedia signal before the insertion of the user data as an imperceptible watermark. And a “watermarked multimedia signal” is the digital multimedia signal after the insertion of user data as an imperceptible watermark.

The first device transmits or stores the watermarked signal. For example, the first device either directly or through one or more intermediate devices may present or send the watermarked signal for one or more parties. Therefore the first device includes the necessary hardware and software for sending or transmitting the watermarked signal.

Between the time user data is embedded into the host signal and the time the host signal is consumed again (for example, a digital image or video is viewed again), the circumstances surrounding the capture of the host signal might be forgotten or lost.

The second device is configured to receive one or more digital multimedia signals from one or more sources. To that end, the second device may be a digital camera, digital video recorder, desktop computer, a laptop computer, a server, a mobile telephone, a portable digital assistant, or other type of portable or stationary computer or communication device and include all necessary software, controllers, memory devices, connections, antennas, modems, and other accessories to operate such devices and receive the signals. The second device may be configured to receive the signals through a variety of means including but not limited to a network, such as the Internet or an intranet, as an electronic mail, or in accordance with other downloading formats or processes.

The second device is also configured to extract user data from the received digital signals. The second device's extraction strategy, i.e., retrieving embedded user data, may be essentially the first device's insertion strategy, i.e., embedding user data into the signal, in reverse. As such, the second device may be advised of the first device's insertion strategy in advance so as to guide its extraction strategy. Once user data is recovered from the watermarked multimedia signal, it can be output to a user in accordance with the type of user data. For example, if the user data is text, it can be displayed or printed out as characters to a user or if the user data is an audio signal, it can be played back via speakers.

According to the illustrated embodiment of FIG. 3, the second device 20 includes a receiving element 21, such as an antenna, a receiver or other input device, for receiving the watermarked digital multimedia signal, an extracting element 22 for extracting user data in the form of a watermark from the digital multimedia signal, a memory element 23 for storing digital signals, an output element 24 to output the user data and a processing element 25 configured to regulate or control the functions of the other elements. The processing element may be comprised of a processor or other computing device and may serve not only to regulate or control the functions of the other elements, but may, in fact, serve as one or more of the other elements, such as the extracting element.

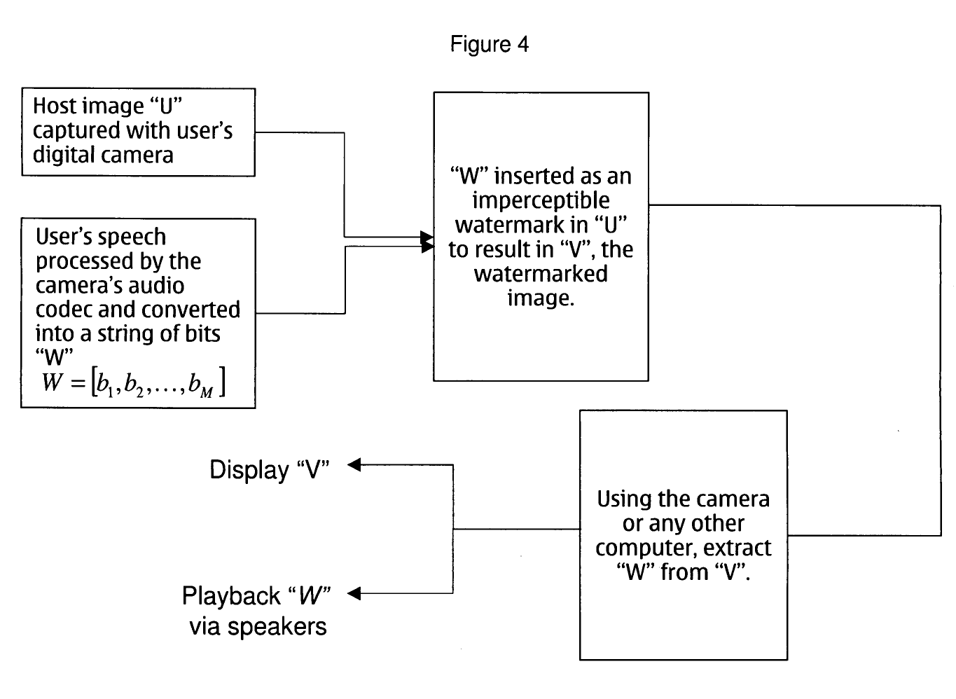

FIGS. 4-6 illustrate few other embodiments of the present invention. For illustration purposes only and as shown in FIG. 4, the host signal of the illustrated embodiment may represent an image, referred to as a host image and represented by a matrix U. This image may be captured using user's digital camera. The watermark W is a sequence of M bits b, i.e. W=[b₁, b₂, . . . b_{M}] which may be the output of the audio coder present in the camera to a segment of user's speech describing the circumstances surrounding the image capture. The number M of bits that make up the watermark W may vary depending upon the amount of user speech and the type of audio coder. W is inserted as an imperceptible watermark into the host image U, using any of the various techniques known for imperceptible watermarking, thus creating a watermarked image, V One of ordinary skill in the art will appreciate that user data can be in the form of text or video as well, which after conversion to digital format, are represented simply by bits.

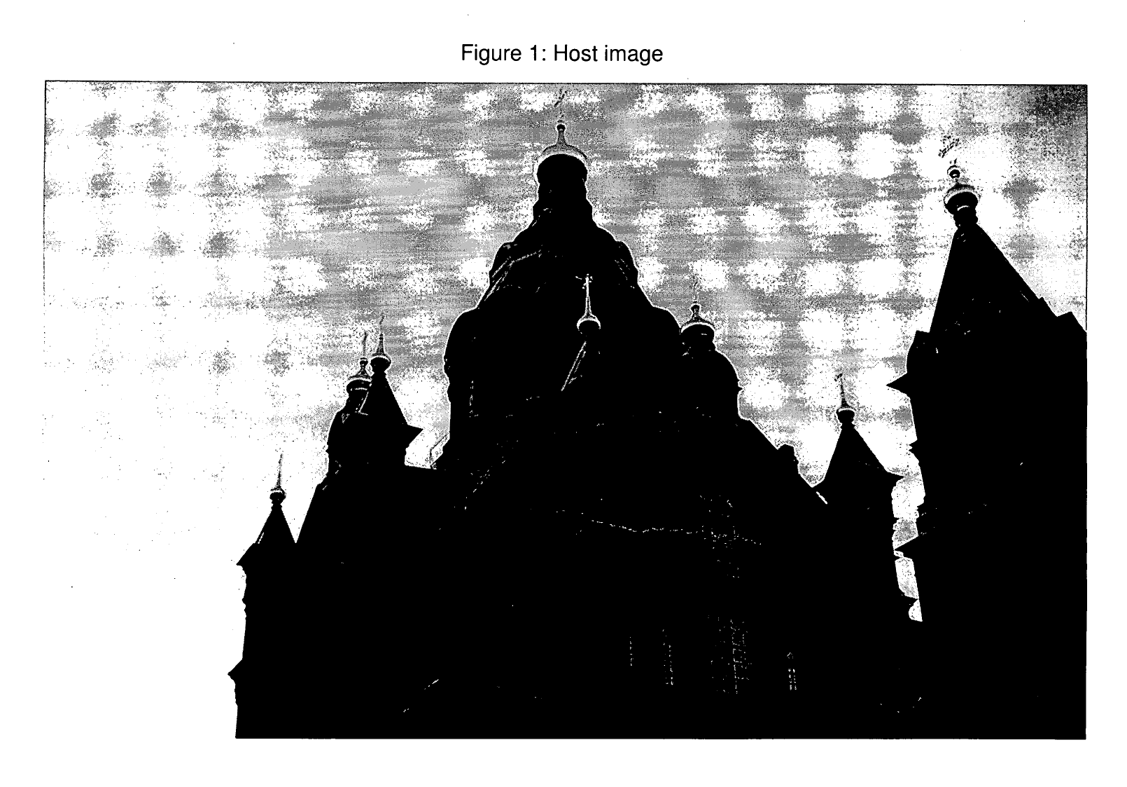

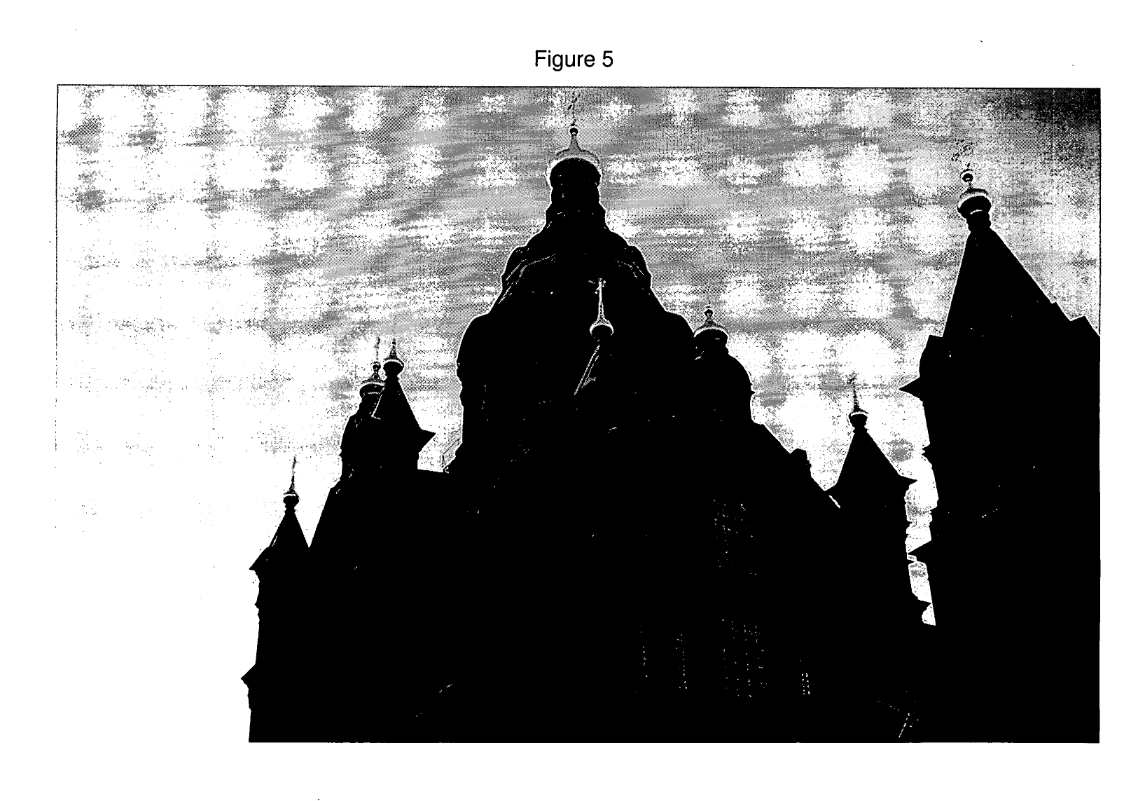

A commonly used voice coder has an output data rate of 13 kbps. Assuming user data is in form of speech signal being coded by a 13 kbps voice coder, 10 seconds of speech will amount to 130,000 bits. As an example, image in FIG. 1 was taken and 130,000 bits (equivalent to 10 seconds of speech) were embedded as watermark into this image by replacing the least significant bits of the red pixels. The watermarked image is displayed in FIG. 5. As can be seen from FIG. 5, the watermark is completely imperceptible. Similar results were obtained by placing the watermark in the blue and the green color planes and by staggering the watermark across all three color planes.

At a later time, when a user wants to view the image, knowledge of the watermarking process performed to insert W into U can be used to extract W. Image V can be displayed to the user and speech W or user data can be played back. User can get a full account of the circumstances relating to the image capture without having to rely on his personal memory or cumbersome bookkeeping methods and without compromising the aesthetic quality of the image.

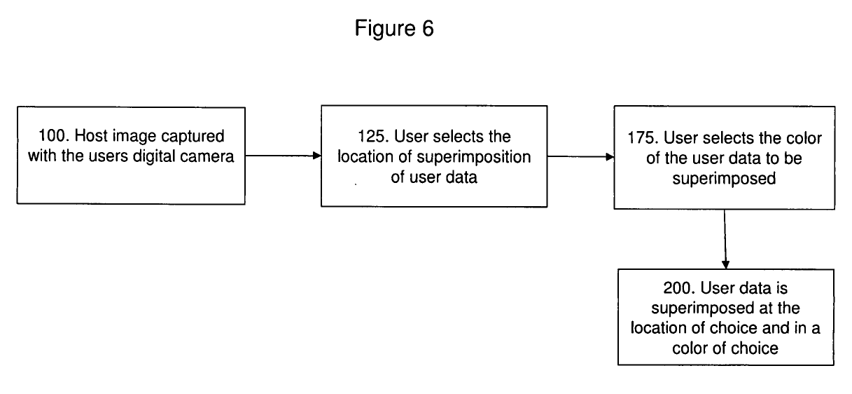

In another embodiment of the invention, as illustrated in FIG. 6, user data may be superimposed in the least obtrusive manner rather than imperceptibly watermarked on the host image. This may be achieved by intelligently selecting the location and the color of the superimposed data. To place the superimposed data at the least obstruction location, user can be prompted to select the location on the image or the location can be automatically chosen by a processor. The processor may use many of the known algorithms to select a location on the image with the least amount of information. One criterion for selecting the location of superimposition can be the area with low spatial frequencies. A low frequency area in an image implies an area where the color does not change significantly over an image area (a picture of the blue sky). Hence, the image can be passed through a low pass filter to identify areas of low frequency for positioning of user data.

The color of the superimposed data can be selected by the user by indicating a color of choice on a color palette or the processor can choose a color similar to the color of the background where on which the user data will be superimposed. For example, a color similar to the background color can be one in which the values of hue and saturation are the same but the luminance is higher or lower by a small amount (say, 20%). It is to be noted that there is no need to extract user data if it is superimposed since user data is visible to the naked eye. Also, in this case, only text data can be superimposed.

The above described functions may be carried out in many ways. Any suitable means for carrying out each of the functions described above may be employed to carry out the invention. In one embodiment, all or a portion of the elements of the invention generally operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium, such as the memory element of the first and/or second device(s).

Many modifications and other embodiments of the invention set forth herein will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. Method comprising:
embedding user data into a digital multimedia signal as an imperceptible watermark; wherein
user data comprises information helpful in indexing the digital multimedia signal.

2. Method according to claim 1, wherein embedding of user data is done substantially concurrently with the capture of the digital multimedia signal.

3. Method according to claim 1, wherein user data comprises chronological information regarding the capture of the digital multimedia signal.

4. Method according to claim 1, wherein user data comprises information about the events associated with the capture of the digital multimedia signal.

5. Method according to claim 1, wherein user data comprises information about a user or owner of the multimedia content.

6. Method according to claim 1, wherein user data user data is input in the form of text, audio or video signals.

7. An apparatus comprising:
a receiver for receiving a digital multimedia signal;
a receiver for receiving user data; and
a processor for embedding user data into a digital multimedia signal as an imperceptible watermark.

8. An apparatus according to claim 7, wherein the apparatus further comprises a digital imaging apparatus for capturing digital multimedia signals.

9. An apparatus according to claim 7, wherein the apparatus further comprises a screen for displaying digital multimedia signals.

10. An apparatus according to claim 7, wherein the apparatus further comprises an input device capable of accepting user data.

11. An apparatus according to claim 7, wherein user data comprises chronological information regarding the capture of the digital multimedia signal.

12. An apparatus according to claim 7, wherein user data comprises information about the events associated with the capture of the digital multimedia signal.

13. An apparatus according to claim 7, wherein user data comprises information about a user or owner of the multimedia content.

14. An apparatus according to claim 7, wherein user data user data is input in the form of text, audio or video signals.

15. An apparatus according to claim 7, further comprising a microphone for receiving user data in the form of audio signals.

16. An apparatus comprising:
a receiver for receiving a digital multimedia signal in which user data has been embedded as an imperceptible watermark;
an extractor for extracting the user data from the digital multimedia signal;
an output device for outputting the multimedia signal; and
an output device for outputting the user data.

17. An apparatus according to claim 16 such that the output user data is in the form of text, audio or video signals.
